(19) United States
(12) Patent Application Publication
(10) Pub. No.: US 2021/0300004 A1
(43) Pub. Date: Sep. 30, 2021

(54) LAYERED FILM, LAMINATE FILM, AND PACKAGING CONTAINER

(71) Applicant: DIC Corporation, Tokyo (JP)

(72) Inventors: Younosuke Konemura, Kitaadachi-gun (JP); Takashi Moriya, Kitaadachi-gun (JP)

(73) Assignee: DIC Corporation, Tokyo (JP)

(21) Appl. No.: 16/330,577

(22) PCT Filed: Sep. 21, 2017
(86) PCT No.: PCT/JP2017/034066

§ 371 Date: Mar. 5, 2019

(30) Foreign Application Priority Data
Oct. 3, 2016 (JP) 2016-195810

(51) Int. Cl. B32B 27/08; B32B 27/32; B32B 7/02; B65D 65/40

(52) U.S. Cl. CPC B32B 27/08; B32B 27/32; B32B 7/02; B32B 2307/31; B32B 2307/732; B32B 2439/40; B32B 2307/72; B65D 65/40

(57) ABSTRACT

Provided is a layered film having suitable easy-unsealability and having high sealing strength even under high temperature. A layered film with such suitable easy-unsealability and high sealing strength under high temperature includes a surface layer (A), an intermediate layer (B), and a seal layer (C), in which the surface layer (A) and the seal layer (C) each includes a polypropylene-based resin as a main component, the intermediate layer (B) includes a polypropylene-based resin (b1) and a polyethylene-based resin (b2), resin components in the intermediate layer (B) has a polypropylene-based resin (b1) content of 40 to 70% by mass and a polyethylene-based resin (b2) content of 30 to 60% by mass, the intermediate layer (B) has a thickness of 15% or less of the overall thickness of the layered film, and the seal layer (C) has a thickness of 15% or less of the overall thickness of the layered film.

### TECHNICAL FIELD

The present invention relates to a layered film that is excellent in easy-unsealability as a sealant film and that can be sterilized under high temperature, a laminate film, and a packaging container.

### BACKGROUND ART

Packaging containers, such as packaging containers of foods for boil cooking or retort foods and packaging containers of contact lenses or other hygiene articles, are required to have high sealability so that contents are not leaked in heat sterilization and the containers are not opened by impact in distribution. On the other hand, the containers are also required to have easy-unsealability so that the containers can be easily opened when they are to be opened.

As a film having suitable sealability and easy-unsealability, for example, a composite film in which a polypropylene-based seal layer and a resin layer mainly containing a polyethylene-based resin are layered (see PTL 1), a multilayered film in which a seal layer containing a polypropylene-based resin and a polyethylene-based resin and a resin layer containing a polypropylene-based resin are layered (see PTL 2), and the like are disclosed.

### CITATION LIST

### Patent Literature

PTL 1: JP-A-2001-310431
PTL 2: JP-A-2003-322888

### SUMMARY OF INVENTION

### Technical Problem

In recent years, packaging containers for foods and hygiene articles are further required to have resistance to heat sterilization treatments under further higher temperature due to request for higher hygiene, longer use-by date, and higher production efficiency. The foregoing films have suitable sealability and easy-unsealability, but since the inner pressure in the packaging container increases under high temperatures exceeding 130° C., there is a need for further improved sealing strength under high temperature.

An object of the present invention is to provide a layered film that has suitable easy-unsealability and has high sealing strength even under high temperature.

### Solution to Problem

To solve the above problem, the present invention is directed to a layered film including a surface layer (A), an intermediate layer (B), and a seal layer (C), in which the surface layer (A) and the seal layer (C) each includes a polypropylene-based resin as a main component, the intermediate layer (B) includes a polypropylene-based resin (b1) and a polyethylene-based resin (b2), resin components in the intermediate layer (B) has a polypropylene-based resin (b1) content of 40 to 70% by mass and a polyethylene-based resin (b2) content of 30 to 60% by mass, the intermediate layer (B) has a thickness of 15% or less of the overall thickness of the layered film, and the seal layer (C) has a thickness of 15% or less of the overall thickness of the layered film.

### Advantageous Effects of Invention

The layered film of the present invention has excellent easy-unsealability so as to be easily unsealable, and can keep suitable sealing strength even upon a heat sterilization treatment at a high temperature exceeding 130° C. Accordingly, the layered film of the present invention can be suitably used as a sealant film for various packaging containers to be subjected to a high temperature treatment, such as heat sterilization. In particular, a laminate film in which the layered film of the present invention is used as a sealant film is suitable as a lid material for sealing an opening of a packaging container having the opening to be used for packaging a food, a hygiene article, a medical article, or the like.

### DESCRIPTION OF EMBODIMENTS

The layered film of the present invention is a layered film including a surface layer (A), an intermediate layer (B), and a seal layer (C), the surface layer (A) and the seal layer (C) each including a polypropylene-based resin as a main component, the intermediate layer (B) including a polypropylene-based resin (b1) and a polyethylene-based resin (b2). In addition, resin components in the intermediate layer (B) has a polypropylene-based resin (b1) content of 40 to 70% by mass and a polyethylene-based resin (b2) content of 30 to 60% by mass. The thickness of the intermediate layer (B) in the layered film is 15% or less of the overall thickness of the layered film, and the thickness of the seal layer (C) in the layered film is 15% or less of the overall thickness of the layered film.

### [Surface Layer (A)]

The surface layer (A) for use in the layered film of the present invention contains a polypropylene-based resin as a main component. When a polypropylene-based resin is used as a surface layer, the heat resistance of the layered film can be increased. Examples of polypropylene-based resins include propylene homopolymers and copolymers of propylene and an α-olefin, such as ethylene or butene-1. As the copolymer, either of a random copolymer and a block copolymer may be used. Preferred examples among them include propylene homopolymers, propylene-ethylene random copolymers, and propylene-ethylene-butene-1 random copolymers. In a propylene-based random copolymer, such as the propylene-ethylene random copolymer or the propylene-ethylene-butene-1 random copolymer, the content of the propylene-derived component in the copolymer is preferably 90% by mole or more, and more preferably 92 to 98% by mole. The polypropylene-based resins (a) may be used alone or may be used in mixture.

The polypropylene-based resin preferably has a melting point of 130° C. or higher, and more preferably 140° C. or higher. By using a polypropylene-based resin having such a melting point, heat resistance for retaining sealing strength under high temperature can be achieved. The melting point is an endothermic peak temperature determined with a differential scanning calorimeter (DSC).

The content of the polypropylene-based resin in the surface layer (A) is preferably 80% by mass or more of resin components contained in the surface layer (A), and more preferably 90% by mass or more. With a content of the polypropylene-based resin within this range, heat resistance can be retained.

In the surface layer (A), a resin other than the polypropylene-based resin may be used together. As the other resin, an olefin-based resin other than the polypropylene-based resin, or recycled materials, such as film end portions generated in production of propylene-based films can be used. As the olefin-based resin other than the polypropylene-based resin, polyethylene-based resins are preferred. Examples of such resins include polyethylene resins, such as linear low density polyethylenes (LLDPE), low density polyethylenes (LDPE), medium density polyethylenes (MDPE), and high density polyethylenes (HDPE), ethylene-vinyl acetate copolymers, ethylene-methyl acrylate copolymers, ethylene-ethyl acrylate copolymers, and ethylene-methacrylic acid copolymers. Among them, polyethylene resins are preferred, linear low density polyethylenes (LLDPE) and high density polyethylenes (HDPE) are particularly preferred, and a liner low density polyethylene (LLDPE) having a density of 0.918 to 0.950 g/cm³ is most preferred. The ethylene-based resins may be used alone or used in mixture.

The content of the other resin in the surface layer (A) is preferably 20% by mass or less of resin components contained in the surface layer (A), and in terms of heat resistance, the content is more preferably 10% by mass or less.

In the surface layer (A), an additive, such as a lubricant, a blocking inhibitor, a UV absorber, a photostabilizer, an antistatic agent, an antifogging agent, or a colorant may be appropriately added.

### [Intermediate Layer (B)]

The intermediate layer (B) for use in the present invention contains a polypropylene-based resin (b1) and a polyethylene-based resin (b2), and the content of the polypropylene-based resin (b1) in resin components contained in the intermediate layer (B) is 40 to 70% by mass, while the content of the polyethylene-based resin (b2) therein is 30 to 60% by mass. In the present invention, by using the intermediate layer, suitable easy-unsealability and high sealing strength under high temperature can be attained.

As the polypropylene-based resin (b1) for use in the intermediate layer, as with the case of the polypropylene-based resins mentioned for the surface layer (A), a propylene homopolymer, a copolymer of propylene and an α-olefin, such as ethylene or butene-1, or the like may be used, and as the copolymer, a random copolymer or a block copolymer may be used. Among them, a propylene-ethylene random copolymer and a propylene-ethylene-butene-1 random copolymer are preferred. The polypropylene-based resins (b1) may be used alone or may be used in mixture.

The melting point of the polypropylene-based resin (b1) is preferably 130° C. or higher, and more preferably 140° C. or higher. By using the polypropylene-based resin (b1) having such a melting point, sealing strength under high temperature can be retained.

The melt flow rate of the polypropylene-based resin (b1) at 230° C. is preferably 1.0 to 10 g/10 min, and more preferably 3.0 to 8.0 g/10 min. With a melt flow rate within this range, suitable easy-unsealability and extrudability are easily achieved.

As the polyethylene-based resin (b2) for use in the intermediate layer, as with the case of the polyethylene-based resins mentioned for the surface layer (A), a polyethylene resin, such as a linear low density polyethylene (LLDPE), a low density polyethylene (LDPE), a medium density polyethylene (MDPE), or a high density polyethylene (HDPE), an ethylene-vinyl acetate copolymer, an ethylene-methylacrylate copolymer, an ethylene-ethyl acrylate copolymer, an ethylene-methacrylic acid copolymer, or the like may be used. Among them, a high density polyethylene (HDPE) or a linear low density polyethylene (LLDPE) is preferably used. The ethylene-based resins may be used alone or may be used in mixture.

When a high density polyethylene is used, a high density polyethylene resin having a density of 0.940 to 0.965 g/cm³ can be preferably used, and a high density polyethylene resin having a density of 0.950 to 0.965 g/cm³ is particularly preferably used since suitable heat resistance is easily achieved.

The melting point of the polyethylene-based resin (b2) is preferably 130° C. or higher, and more preferably 132° C. or higher. By using the polyethylene-based resin (b2) having such a melting point, sealing strength under high temperature can be retained.

The melt flow rate of the polyethylene-based resin (b2) at 190° C. is preferably 2 to 20 g/10 min, and more preferably 5 to 15 g/10 min. By using the polyethylene-based resin (b2) having such a melt flow rate, good dispersibility is easily achieved in melt-kneading with the polypropylene-based resin (b1) and extruding, and suitable sealing strength is easily attained.

The content of the polypropylene-based resin (b1) in resin components contained in the intermediate layer (B) is preferably 40 to 70% by mass, and more preferably 45 to 60% by mass. Meanwhile, the content of the polyethylene-based resin (b2) in resin components contained in the intermediate layer (B) is preferably 30 to 60% by mass, and more preferably 40 to 55% by mass. With contents of the resins in these ranges, suitable sealing strength, in particular, suitable sealing strength under high temperature and easy-unsealability are easily achieved.

The ratio of the content of the polypropylene-based resin (b1) to the content of the polyethylene-based resin (b2) are preferably 70/30 to 50/50, and more preferably 60/40 to 50/50. With such a ratio of the contents, suitable sealing strength can be achieved.

In the intermediate layer (B), an additive may be appropriately used as with the case of the surface layer (A).

### [Seal Layer (C)]

The seal layer (C) for use in the layered film of the present invention contains a polypropylene-based resin as a main component. When a polypropylene-based resin is used as a seal layer, heat resistance of the layered film can be enhanced and suitable adhesiveness to a packaging container is easily ensured. As the polypropylene-based resin, the same resins as mentioned as the polypropylene-based resin in the surface layer (A) can be suitably used.

Among them, examples of the polypropylene-based resins for use in the seal layer (C) include propylene homopolymers and copolymers of propylene and α-olefin, such as ethylene and butene-1, and as the copolymer, either of a random copolymer and a block copolymer may be used. Preferred examples among them include propylene-ethylene random copolymers and propylene-ethylene-butene-1 random copolymers. The polypropylene-based resins (a) may be used alone or may be used in mixture.

The polypropylene-based resin for use in the seal layer (C) preferably has a melting point of 130° C. or higher, and more preferably 140° C. or higher. By using a polypropylene-based resin having such a melting point, suitable heat resistance and sealing start temperature are achieved.

The polypropylene-based resin for use in the seal layer (C) preferably has a melt flow rate at 230° C. of 0.5 to 15 g/10 min, and more preferably 3 to 12 g/10 min. With a melt flow rate within this range, suitable extrudability is easily achieved.

The content of the polypropylene-based resin in the seal layer (C) is preferably 90% by mass or more of resin components contained in the seal layer (C), and more preferably 95% by mass or more. Within this range, suitable heat resistance is easily retained.

A resin other than the polypropylene-based resin may be used together in the seal layer (C). As the other resin, the same resins as mentioned as a resin other than the polypropylene-based resins in the surface layer (A) can be suitably used.

The content of the other resin in the seal layer (C) is preferably 20% by mass or less of resin components contained in the seal layer (C), more preferably 5 to 20% by mass, and further preferably 5 to 10% by mass. Within this range, heat resistance is easily retained, and suitable sealing strength is easily achieved.

Also in the seal layer (C), an additive may be appropriately used as with the case of the surface layer (A).

### [Layered Film]

The layered film of the present invention is a film in which at least the surface layer (A), the intermediate layer (B), and the seal layer (C) are layered. The layered film has a structure in which one surface layer is the surface layer (A) and the other surface layer is the seal layer (C), and the intermediate layer (B) is present between the surface layer (A) and the seal layer (C). The layered film of this structure can attain high heat resistance as the whole layered film owing to both the surface layers each containing a polypropylene-based resin having high heat resistance as a main component. In addition, the seal layer (C) which contains a polypropylene-based resin as a main component and the intermediate layer (B) which contains a polypropylene-based resin having high heat resistance and a polyethylene-based resin in the ratio as described above are used. Furthermore, the thickness of the intermediate layer (B) and the thickness of the seal layer (C) are each 15% or less of the overall thickness of the layered film. This facilitates cut of the seal layer (C) and cohesive failure of the intermediate layer (B) in opening after sealing, and thus high sealing strength can be kept against increased internal pressure under high temperature, while suitable easy-unsealability in opening can be attained.

The thickness of the seal layer (C) in the layered film of the present invention is 15% or less of the overall thickness of the film, and preferably in the range of 5 to 15%. With a thickness of the seal layer (C) within this range, heat sealing strength is stabilized, leading to moderate easy-unsealability, and residual film in opening is less likely to occur. The thickness of the intermediate layer (B) is 15% or less of the overall thickness of the film, and preferably in the range of 5 to 15%. With a thickness of the intermediate layer (B) within this range, heat sealing strength is stabilized, leading to moderate easy-unsealability.

The thickness of the surface layer (A) in the layered film of the present invention is preferably 90% or less of the overall thickness of the film, more preferably 50 to 80%, and further preferably 60 to 80%. With a thickness of the surface layer within this range, suitable heat resistance, stable heat sealing strength, and suitable easy-unsealability are easily achieved.

The overall thickness of the layered film of the present invention is preferably 15 to 100 μm, and in terms of easy-unsealability, the overall thickness is more preferably 20 to 60 μm. With such a thickness, the layered film is easily suitably applied particularly to a film for a lid material of a packaging container.

The surface layer (A), the intermediate layer (B), and the seal layer (C) each may be a single layer or may be formed of a plurality of layers. When the layer is formed of a plurality of layers, layers having the same formulation may be layered, or layers having different formulations may be layered. Note that the layered film of the present invention has a structure in which the intermediate layer (B) and the seal layer (C) are directly layered.

Examples of preferred structure of the layered film of the present invention include a structure of surface layer (A)/intermediate layer (B)/seal layer (C) and a structure of surface layer (A1)/surface layer (A2)/intermediate layer (B)/seal layer (C) which has two surface layers.

Since a proportion of the surface layer (A) in the overall thickness is especially high in the present invention, multilayer structure having two or more layers is preferably adopted for easy adjustment of the thicknesses of the heat seal intermediate layer (B) and the seal layer (C) when coextrusion is used. This is because a multilayered film excellent in uniformity can be produced with this structure. In this case, the resin mixtures constituting the respective layers in the surface layer (A) having two or more layers only have to have a polypropylene-based resin as a main component, and may be the same mixture, or may be mixtures of resins having different melt flow rates (MFR) or different densities, mixtures having different mixing ratio, or the like.

In addition, the layered film of the present invention may have a layer other than the above surface layer (A), intermediate layer (B), and seal layer (C), such as a barrier layer, to the extent that the effects of the present invention are not impaired. When the other layer is provided, the thickness of the other layer is preferably 10% or less of the overall thickness of the layered film.

The layered film of the present invention should be produced by a coextrusion lamination molding method in which layers are layered in a structure of surface layer (A)/intermediate layer (B)/seal layer (C). For example, preferred is a method in which the surface layer (A), the intermediate layer (B), and the seal layer (C) are layered in a molten state by a known coextrusion process in which melt-extrusion is performed using three or more extruders, such as a coextrusion multilayer dice process and a feed block process, and then the resultant is processed into a long wound film by a technique, such as an inflation or a T-die chill rolling method. A coextrusion method with a T-die is more preferred.

### [Laminate Film]

The layered film of the present invention can be formed into a laminate film by laminating a substrate on the surface layer (A). Examples of such substrates include biaxially oriented polyester film, biaxially oriented nylon film, nonwoven fabric, aluminum foil, and paper. Such substrates may be used alone, or two or more layered films may be used as the substrate.

Examples of methods for laminating a substrate on the layered film include a dry lamination method, a heat lamination method, and a multilayer extrusion coating method, and among them, a dry lamination method is more preferred. Examples of adhesives for use in lamination of the coextruded layered film of the present invention and a substrate by a dry lamination method include polyether-polyurethane adhesives and polyester-polyurethane adhesives.

The surface of the resin layer (A) before lamination of the layered film of the present invention and a substrate is preferably subjected to a corona discharge treatment since adhesiveness to the substrate is then enhanced.

### [Packaging Container]

The laminate film can be suitably used as a material for various packages, and can be incorporated into a packaging container by sealing an opening of a container having the opening with the laminate film. In particular, the laminate film is best suited as a lid material for sealing an opening of a packaging container having the opening for a food, a hygiene article, a medical article, or the like. When the laminate film of the present invention is used as a lid material, the heat seal surface of the opening of the packaging container preferably contains a polypropylene-based resin as a main component. When the heat seal surface contains a polypropylene-based resin as a main component, high heat resistance is easily attained, and the sealing strength between an opening of a packaging container and a lid material is at a proper level, and a packaging container that is excellent in easy-unsealability and can keep sealing strength at such a level that the content therein does not leak in a heat treatment can be produced.

Examples of such polypropylene-based resins include homopolymers of propylene and copolymers of propylene and an α-olefin, such as propylene homopolymers, propylene-ethylene copolymers, propylene-butene-1 copolymers, and propylene-ethylene-butene-1 copolymers. Among the polypropylene-based resins, a resin having a content of the propylene monomer unit of 70% by mole or higher in the polymer is preferred since sufficient sealing strength is then achieved.

The heat seal surface of the opening of the packaging container contains a polypropylene-based resin as a main component. The content thereof is more preferably 60% by mass or more, and further preferably 80% by mass or more. A content of the polypropylene-based resin in the heat seal surface within this range is preferred since sufficient sealing strength is achieved. Any resin can be used in combination with the polypropylene-based resin in the heat seal surface with no limitation as long as the resin is compatible with the polypropylene-based resin and does not inhibit the heat sealing, and examples of such resins include polyethylene-based resins, such as ethylene homopolymers and ethylene-α-olefin copolymers.

### EXAMPLES

The present invention is specifically explained below with respect to Examples and Comparative Examples, but the present invention is not limited to the examples. Parts and % in the examples are all by weight.

The following evaluations were performed for layered films obtained in Examples and Comparative Examples as described above. The results are shown in tables.

### (1) Evaluation of Easy-Peelability

A biaxially oriented nylon film having a thickness of 15 μm was laminated on the surface layer (A) side of the obtained film with a urethane-based adhesive to produce a laminate film. The heat seal layer of the obtained laminate film was superposed on a polypropylene sheet having a thickness of 0.3 mm, and they were heat sealed for 1.0 seconds with a precise heat sealer (manufactured by Tester Sangyo Co. Ltd.) at a temperature of 200° C. and a pressure of 0.2 MPa using a 10 mm width seal bar, and were allowed to cool. Then, a sample piece of 15 mm width was cut from the heat sealed sample, and was subjected to peeling in a thermostat at 23° C. and 50% RH at a peeling rate of 300 mm/min in the direction of 180 degrees with a universal tensile tester (manufactured by A & D Company, Limited) to measure the maximum load. (unit: N/15 mm)

### (2) Evaluation of Heat Resistance

The heat seal layer of the laminate film was superposed on the sheet, and they were heat sealed with a precise heat sealer at a temperature of 200° C. and a pressure of 0.2 MPa using a 10 mm width seal bar for 1.0 seconds, and were allowed to cool. Then, a sample piece of 15 mm width was cut from the heat sealed sample, and was subjected to peeling in a thermostatic chamber at 130° C. at a peeling rate of 300 mm/min with a universal tensile tester (manufactured by A & D Company Limited) in the direction of 180 degrees to measure the maximum load. (unit: N/15 mm)

### Example 1

The surface layer (A) had a two-layer structure. A propylene homopolymer [density: 0.89 g/cm³, MFR (230° C.): 3 g/10 min; hereinafter referred to as HOPP] synthesized using a multisite catalyst was used as a resin for a surface layer (A1) and a surface layer (A2), a mixture of 60 parts of a propylene-ethylene copolymer [melting point: 135° C., density: 0.89 g/cm³, MFR (230° C.) 7 g/10 min; hereinafter referred to as COPP (1)] and 40 parts of a high density polyethylene [density: 0.960 g/cm³, MFR (190° C.): 7 g/10 min; hereinafter referred to as HDPE] was used as the intermediate layer (B), and a propylene-ethylene copolymer [melting point: 140° C., density: 0.89 g/cm³, MFR (230° C.): 7.5 g/10 min; hereinafter referred to as COPP (2)] synthesized using a multisite catalyst was used as a resin for the seal layer (C). The respective resins were fed to an extruder (diameter: 50 mm) for the surface layer (A1), an extruder (diameter: 50 mm) for the surface layer (A2), an extruder (diameter: 40 mm) for the intermediate layer (B), and an extruder (diameter: 40 mm) for the seal layer (C), and the resins were extruded by a coextrusion method from a T-die at an extrusion temperature of 250° C. so that the thicknesses of the layers (A1)/(A2)/(B)/(C) were 20/20/5/5 (μm). The extruded layers were cooled with a water-cooled metal cooling roll at 40° C. and subjected to a corona discharge treatment so that the wet tension of the surface layer (A) was 40 mN/m, and then were wound in a roll. The roll was aged in an aging room at 35° C. for 48 hours to produce a coextruded multilayered film having a overall thickness of 50 μm.

### Example 2

A coextruded layered film of Example 2 was produced in the same manner as in Example 1 except that a mixture of 50 parts of COPP (1) and 50 parts of HDPE was used as a resin for the intermediate layer (B).

### Example 3

A coextruded layered film of Example 3 was produced in the same manner as in Example 1 except that a mixture of 70 parts of COPP (1) and 30 parts of HDPE was used as a resin for the intermediate layer (B).

### Example 4

A coextruded layered film of Example 4 was produced in the same manner as in Example 1 except that a mixture of 60 parts of COPP (1) and 40 parts of HDPE was used as a resin for the intermediate layer (B) and that the resins were extruded so that the thicknesses of the layers (A1)/(A2)/(B)/(C) were 15/20/7.5/7.5 (μm).

### Example 5

A coextruded layered film of Example 5 was produced in the same manner as in Example 1 except that a mixture of 50 parts of COPP (1) and 50 parts of HDPE was used as a resin for the intermediate layer (B) and that the resins were extruded so that the thicknesses of the layers (A1)/(A2)/(B)/(C) were 15/20/7.5/7.5 (μm).

### Example 6

A coextruded layered film of Example 6 was produced in the same manner as in Example 1 except that a mixture of 70 parts of COPP (1) and 30 parts of HDPE was used as a resin for the intermediate layer (B) and that the resins were extruded so that the thicknesses of the layers (A1)/(A2)/(B)/(C) were 15/20/7.5/7.5 (μm).

### Comparative Example 1

A coextruded layered film of Comparative Example 1 was produced in the same manner as in Example 1 except that a mixture of 80 parts of COPP (1) and 20 parts of HDPE was used as a resin for the intermediate layer (B) and that the resins were extruded so that the thicknesses of the layers (A1)/(A2)/(B)/(C) were 20/20/5/5 (μm).

### Comparative Example 2

A coextruded layered film of Comparative Example 2 was produced in the same manner as in Example 1 except that a mixture of 30 parts of COPP (1) and 70 parts of HDPE was used as a resin for the intermediate layer (B) and that the resins were extruded so that the thicknesses of the layers (A1)/(A2)/(B)/(C) were 20/20/5/5 (μm).

### Comparative Example 3

A coextruded layered film of Comparative Example 3 was produced in the same manner as in Example 1 except that a mixture of 50 parts of COPP (1) and 50 parts of HDPE was used as a resin for the intermediate layer (B) and that the resins were extruded so that the thicknesses of the layers (A1)/(A2)/(B)/(C) were 10/20/10/10 (μm).

### Comparative Example 4

A coextruded layered film of Comparative Example 4 was produced in the same manner as in Example 1 except that a mixture of 70 parts of a propylene-ethylene copolymer [melting point: 125° C., density: 0.89 g/cm³, MFR (230° C.): 7 g/10 min; hereinafter referred to as COPP (3)] and 30 parts of HDPE was used as a resin for the intermediate layer (B) and that the resins were extruded so that the thicknesses of the layers (A1)/(A2)/(B)/(C) were 20/20/5/5 (μm).

### Comparative Example 5

A coextruded layered film of Comparative Example 5 was produced in the same manner as in Example 1 except that a mixture of 50 parts of COPP (3) and 50 parts of HDPE was used as a resin for the intermediate layer (B) and that the resins were extruded so that the thicknesses of the layers (A1)/(A2)/(B)/(C) were 10/20/10/10 (μm).

TABLE 1

| Example | | | 1 | 2 | 3 | 4 | 5 | 6 |
|---|---|---|---|---|---|---|---|---|
| Layer | Surface layer (A1) | HOPP | 100 | 100 | 100 | 100 | 100 | 100 |
| structure | Thickness of surface layer (A1) (μm) | | 20 | 20 | 20 | 20 | 15 | 15 |
| of film | Surface layer (A2) | HOPP | 100 | 100 | 100 | 100 | 100 | 100 |
| | Thickness of surface layer (A2) (μm) | | 20 | 20 | 20 | 20 | 20 | 20 |
| | Structure of intermediate | COPP(1) | 60 | 50 | 70 | 40 | 50 | 70 |
| | layer (B) | HDPE | 40 | 50 | 30 | 60 | 50 | 30 |
| | Thickness of intermediate layer (B) (μm) | | 5 | 5 | 5 | 5 | 7.5 | 7.5 |
| | Seal layer (C) | COPP(2) | 100 | 100 | 100 | 100 | 100 | 100 |
| | Thickness of seal layer (C) (μm) | | 5 | 5 | 5 | 5 | 7.5 | 7.5 |
| | Thickness of whole film (μm) | | 50 | 50 | 50 | 50 | 50 | 50 |
| Evaluation | Peeling strength | 200° C. | 16.6 | 15.5 | 18.0 | 14.3 | 18.5 | 20.5 |

| | | | | | | | |
|---|---|---|---|---|---|---|---|
| results | Evaluation of easy-peelability | Excellent | Excellent | Good | Excellent | Good | Fair |
| | Peeling strength under high temperature | 6.0 | 5.2 | 6.5 | 4.5 | 6.8 | 7.0 |
| | atmosphere | | | | | | |
| | Evaluation of heat resistance | Good | Good | Good | Fair | Good | Good |

TABLE 2

| Comparative Example | | | 1 | 2 | 3 | 4 | 5 |
|---|---|---|---|---|---|---|---|
| Layer | Surface layer (A1) | HOPP | 100 | 100 | 100 | 100 | 100 |
| structure | Thickness of surface layer (A1) (μm) | | 20 | 20 | 10 | 20 | 10 |
| of film | Surface layer (A2) | HOPP | 100 | 100 | 100 | 100 | 100 |
| | Thickness of surface layer (A2) (μm) | | 20 | 20 | 20 | 20 | 20 |
| | Structure of intermediate | COPP(1) | 80 | 30 | 50 | | |
| | layer (B) | COPP(3) | | | | 70 | 50 |
| | | HDPE | 20 | 70 | 50 | 30 | 50 |
| | Thickness of intermediate layer (B) (μm) | | 5 | 5 | 10 | 5 | 10 |
| | Seal layer (C) | COPP(2) | 100 | 100 | 100 | 100 | 100 |
| | Thickness of seal layer (C) (μm) | | 5 | 5 | 10 | 5 | 10 |
| | Thickness of whole film (μm) | | 50 | 50 | 50 | 50 | 50 |
| Evaluation | Peeling strength | 200° C. | 25.0 | 10.0 | 22.4 | 17.2 | 22.0 |

| | | | | | | |
|---|---|---|---|---|---|---|
| results | Evaluation of easy-peelability | Poor | Good | Poor | Excellent | Poor |
| | Peeling strength under high temperature | 7.5 | 1.2 | 7.3 | 1.5 | 1.2 |
| | atmosphere | | | | | |
| | Evaluation of heat resistance | Excellent | Poor | Excellent | Poor | Poor |

As is clear from the above tables, the layered films of the present invention of Examples 1 to 6 had high heat resistance so as to be resistant to peeling under high temperature and had suitable easy-peelability. On the other hand, the films of Comparative Examples 1 to 5 did not have both of the heat resistance and easy-peelability together.

1. A layered film comprising a surface layer (A), an intermediate layer (B), and a seal layer (C),
the surface layer (A) and the seal layer (C) each comprising a polypropylene-based resin as a main component,
the intermediate layer (B) comprising a polypropylene-based resin (b1) and a polyethylene-based resin (b2),
resin components in the intermediate layer (B) having a polypropylene-based resin (b1) content of 40 to 70% by mass and a polyethylene-based resin (b2) content of 30 to 60% by mass,
the intermediate layer (B) having a thickness of 15% or less of the overall thickness of the layered film,
the seal layer (C) having a thickness of 15% or less of the overall thickness of the layered film.

2. The layered film according to claim 1, wherein the polypropylene-based resin (b1) in the intermediate layer (B) comprises a propylene homopolymer and a propylene-ethylene copolymer, and the polyethylene-based resin (b2) is a high density polyethylene resin having a density of 0.940 to 0.965 g/cm³.

3. The layered film according to claim 1, wherein the intermediate layer (B) comprises a high density polyethylene resin having a melting point exceeding 130° C. as the polyethylene-based resin (b2).

4. The layered film according to claim 1, wherein the surface layer (A) comprises 80% by mass or more of a propylene homopolymer.

5. A laminate film comprising the layered film according to claim 1 and a substrate laminated on the surface layer (A) of the layered film.

6. The laminate film according to claim 5, which is for use as a lid material for a packaging container

7. A packaging container comprising a heat seal surface at an opening,
the heat seal surface comprising a polypropylene-based resin as a main component, wherein the opening is sealed with the laminate film according to claim 5.
